(19) United States
(12) Patent Application Publication
(10) Pub. No.: US 2026/0074977 A1
(43) Pub. Date: Mar. 12, 2026

(54) PLAYBACK SIGNAL MANAGEMENT

(71) Applicant: Netflix, Inc., Los Gatos, CA (US)

(72) Inventors: Anirudh Mendiratta, Edmonds, WA (US); Javier Fernandez-Ivern, Prosper, TX (US); Wei Wei, Plano, TX (US); Artem Danylenko, Los Gatos, CA (US); Stan Surmay, Charlotte, NC (US); Zhefeng Du, San Jose, CA (US); Mufaro Emmanuel Makiwa, San Jose, CA (US)

(21) Appl. No.: 18/961,013

(22) Filed: Nov. 26, 2024

Related U.S. Application Data
(60) Provisional application No. 63/693,050, filed on Sep. 10, 2024.

(51) Int. Cl. H04L 43/0852; H04L 41/06; H04L 41/147

(52) U.S. Cl. CPC H04L 43/0852; H04L 41/06; H04L 41/147

(57) ABSTRACT

A computer-implemented method includes receiving, at a server, a threshold number of connection requests from multiple different client devices. The method also includes predicting an amount of time expected to elapse before the server is able to service the connection requests and calculating a retry distribution for the various client devices. The retry distribution indicates a delayed time after which the client devices are to send retry messages to the server based on the predicted amount of time. The method also includes indicating, to the client devices, that the client devices are to send connection requests according to the delayed time specified in the calculated retry distribution. Various other methods, systems, and computer-readable media are also disclosed.

### CROSS-REFERENCE TO RELATED APPLICATIONS

This application claims priority to and the benefit of U.S. Provisional Patent Application No. 63/693,050, filed on Sep. 10, 2024, which application is incorporated by reference herein in its entirety.

### BACKGROUND

Media streaming platforms are often designed to provide on demand movies and television programs to client-side electronic devices. Typically, these movies and television programs are pre-recorded and can be served at any time. In some cases, however, these media streaming platforms may be used to provide live programming. In such cases, many thousands or millions of viewers may be simultaneously streaming the live program from the service. During such an experience, if something were to go wrong with one or more servers on the provisioning side and some portion of the viewers suddenly lost their connection to the streaming platform, many client devices would try to reconnect to the server all at the same time, potentially overloading the server and causing disruption to the streaming of the live program.

### SUMMARY

As will be described in greater detail below, the present disclosure generally describes systems and methods managing playback retries during playback of a media item provisioned by a media streaming platform.

In one example, for instance, a computer-implemented method includes receiving, at a server, at least a threshold number of connection requests from multiple different client devices. The method also includes predicting an amount of time expected to elapse before the server is able to service the connection requests. The method further includes calculating a retry distribution for the client devices, where the retry distribution indicates a delayed time after which at least some of the client devices are to send retry messages to the server based on the predicted amount of time. The method also includes indicating, to the client devices, that the client devices are to send connection requests according to the delayed time specified in the calculated retry distribution.

In some cases, the calculated delayed time is based on at least one health indicator of the server. In some examples, the calculated delayed time is based on a determined restart capacity of the server. In some embodiments, receiving at least the threshold number of connection requests includes identifying at least a threshold number of connection requests that are initiated by users at the respective client devices.

In some examples, the calculated retry distribution adds jitter to the retry messages received from the client devices. In some embodiments, the retry distribution is calculated to include a lowest possible backoff time based on current server operating conditions. In some cases, the connection requests received from the different client devices are received while provisioning a live event at the server. In some embodiments, some of the connection requests are generated by users manually re-starting the stream upon the associated client device losing audio signal or video signal during the live event.

In some examples, receiving at least the threshold number of connection requests includes identifying at least a threshold number of connection requests that are initiated automatically by the respective client devices. In some cases, the method further includes instructing the client devices to store state data indicating a last retry time. In some embodiments, the connection requests correspond to multiple different message types. In some cases, each of the different message types is associated with a different time window for retry distribution.

In some examples, the different time windows for retry distribution are specific to individual media items. In some embodiments, the method further includes determining an error rate for data transferred between the server and a specified client device, and assigning a delayed time for the retry distribution that is based on the determined error rate. In some cases, the delayed time for the retry distribution is based on how many retries can occur while staying below the specified error rate.

In some embodiments, the method further includes conducting a simulation that simulates network traffic between the server and at least one client device and calculating the delayed time for the retry distribution based on the simulation results. In some examples, the method further includes sending control signals to a specified client device indicating that the specified client device is prevented from sending connection requests. In some cases, at least one type of connection request is denied at the server until a different type of connection request is being fulfilled at the server.

A corresponding system includes at least one physical processor and physical memory including computer-executable instructions that, when executed by the physical processor, cause the physical processor to: receive, at a server, at least a threshold number of connection requests from multiple different client devices, predict an amount of time expected to elapse before the server is able to service the connection requests, calculate a retry distribution for the client devices, wherein the retry distribution indicates a delayed time after which some of the client devices are to send retry messages to the server based on the predicted amount of time, and indicate, to the client devices, that the client devices are to send connection requests according to the delayed time specified in the calculated retry distribution.

In some examples, a corresponding non-transitory computer-readable medium is provided that includes one or more computer-executable instructions that, when executed by at least one processor of a computing device, cause the computing device to: receive, at a server, at least a threshold number of connection requests from multiple different client devices, predict an amount of time expected to elapse before the server is able to service the connection requests, calculate a retry distribution for the client devices, wherein the retry distribution indicates a delayed time after which some of the client devices are to send retry messages to the server based on the predicted amount of time, and indicate, to the client devices, that the client devices are to send connection requests according to the delayed time specified in the calculated retry distribution.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an example computer architecture in which the embodiments described herein may operate.

FIG. 2 illustrates a flow diagram of an exemplary method for managing playback retries during playback of a media item provisioned by a media streaming platform.

FIG. 3 illustrates an alternative embodiment of a computing environment in which the embodiments described herein may operate.

FIG. 4 illustrates an embodiment in which a retry distribution is applied across multiple client devices.

FIG. 5 illustrates an embodiment that includes multiple different exemplary retry messages.

FIG. 6 illustrates an embodiment where a delayed retry time is calculated based on different input factors.

FIG. 7 is a block diagram of an exemplary content distribution ecosystem.

FIG. 8 is a block diagram of an exemplary distribution infrastructure within the content distribution ecosystem shown in FIG. 7.

FIG. 9 is a block diagram of an exemplary content player within the content distribution ecosystem shown in FIG. 8.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to managing playback retries during playback of a media item provisioned by a media streaming platform. As noted above, many different companies provide media streaming platforms. Media streaming platforms may be designed to provide on-demand movies, television programs, video games, educational media, or other types of media to client-side electronic devices. These different types of media may be pre-recorded or may be live. For instance, media streaming platforms provided by educational institutions may provide live course lectures or live question and answer sessions with teachers' assistants. Other media streaming platforms may broadcast live sporting events, pay-per-view events, live gaming events, live film releases, or other live media that is not pre-recorded.

In cases where media streaming platforms are providing live media, many thousands or millions of viewers may be streaming the live programs at the same time. Each of these viewers has a client device (e.g., television, smartphone, etc.) that is connected to one of the media streaming platform's servers. In cases where the live media is an event that starts at a specified time, millions of users may attempt to establish a connection with the media streaming platform at the same time. Or, in other cases, users may establish a connection to the platform but may then experience a black screen or audio silence in the live stream. This could then make users restart playback and re-fetch metadata, which can overload platform servers. If many thousands or millions of clients attempt to connect to the server at the same time or restart their connections due to streaming issues, all of those clients' attempts to connect or reconnect to the server would overload the media streaming platform, potentially preventing the platform from serving the media to other client devices.

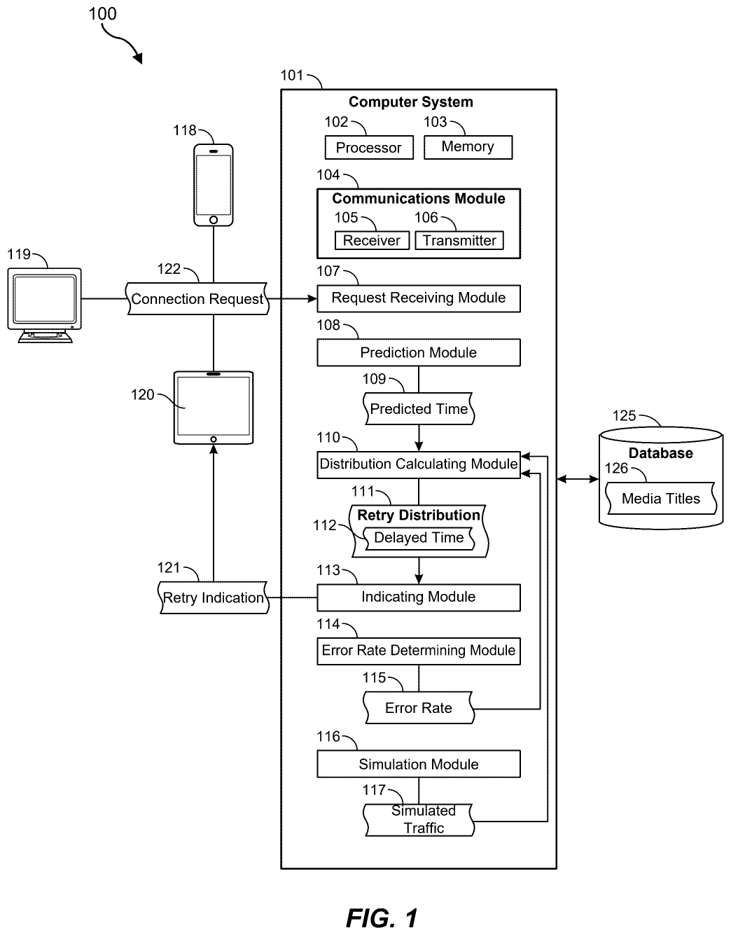

To prevent such scenarios from occurring, or to at least mitigate the adverse results, the systems described herein generate retry distributions that specify when connection requests can be sent from each client device. The systems described herein predict an amount of time that is expected to elapse before a server is able to service the various connection requests that would be sent to it. These systems then use the predicted amount of time to calculate the retry distribution for the client devices that have lost their connections. The retry distribution indicates a customized, delayed time after which the client devices are to send retry messages to the server based on the predicted amount of time. The client devices then reconnect to the server according to the customized, delayed time specified in the retry distribution. These processes will be described in greater detail below with reference to FIGS. 1-9.

FIG. 1, for example, illustrates a computing environment 100 in which playback retries are managed during playback of a media item provisioned by a media streaming platform. FIG. 1 includes various electronic components and elements including a computer system 101 that is used, alone or in combination with other computer systems, to perform associated tasks. The computer system 101 may be substantially any type of computer system including a local computer system or a distributed (e.g., cloud) computer system. The computer system 101 includes at least one processor 102 and at least some system memory 103. The computer system 101 includes program modules for performing a variety of different functions. The program modules may be hardware-based, software-based, or may include a combination of hardware and software. Each program module uses computing hardware and/or software to perform specified functions, including those described herein below.

In some cases, the communications module 104 is configured to communicate with other computer systems. The communications module 104 includes substantially any wired or wireless communication means that can receive and/or transmit data to or from other computer systems. These communication means include, for example, hardware radios such as a hardware-based receiver 105, a hardware-based transmitter 106, or a combined hardware-based transceiver capable of both receiving and transmitting data. The radios may be WIFI radios, cellular radios, Bluetooth radios, global positioning system (GPS) radios, or other types of radios. The communications module 104 is configured to interact with databases, mobile computing devices (such as mobile phones or tablets), embedded computing systems, or other types of computing systems.

The computer system 101 further includes a request receiving module 107. The request receiving module 107 is designed to receive connection requests 122 from various client devices (e.g., smartphone 118, personal computer 119, tablet 120, or other electronic device capable of playing back media). As used herein, “connection requests” or “connection request messages” refer to client communications that request to be initially connected or later reconnected to a server. In the embodiments herein, the computer system 101 may be a server of a media streaming platform or may be a computer system that interfaces with servers of the media streaming platform. The media streaming platform may include a single server or hundreds or thousands of servers (whether physical or virtual servers). Accordingly, when a client device sends a connection request 122, the client devices may be attempting to reconnect to the same server or to different servers that are part of the media streaming platform. The request receiving module 107 receives these connection requests 122 as they come in from the various client devices 118-120.

Once a certain number of connection requests 122 have been received by the request receiving module 107, the prediction module 108 of computer system 101 predicts an amount of time that is expected to elapse before the server is able to service the connection requests 122. This predicted amount of time 109 takes into consideration the current conditions experienced at the server(s). For instance, in some cases, the prediction module 108 determines how many CPU cycles are currently available, how much random-access memory (RAM) is currently available, how much network bandwidth is currently available, how many network connections are available or serviceable with existing hardware, etc. Using this (and potentially other) information, the prediction module 108 generates a predicted time 109 by which the computer system 101 will again be able to service connection requests 122.

Using this predicted time 109, the distribution calculating module 110 then calculates a retry distribution 111. The retry distribution 111 indicates a delayed time 112 after which one or more of the client devices 118-120 are to send retry messages 122 to the server (e.g., computer system 101) based on the predicted amount of time 109. In some cases, each client device has a specified delayed time 112 that is unique to that device. In other cases, groups of client devices may receive the same specified delayed time 112. The indicating module 113 then indicates to the client devices 118-120, via a retry indication 121, each device's delayed time 112 that is to be followed according to the retry distribution 111. The client devices 118-120 then adhere to the delayed time 112 of the retry distribution 111, waiting to send a new connection request 122 until the specified delayed time 112 for that specific client device. Each of these concepts will be described in greater detail with respect to method 200 of FIG. 2 and FIGS. 1-9 below.

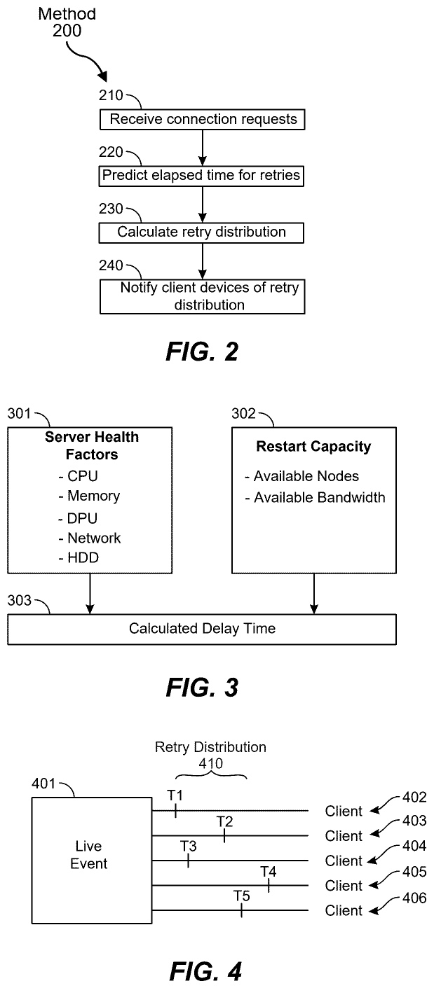

FIG. 2 is a flow diagram of an exemplary computer-implemented method 200 for managing playback retries during playback of a media item provisioned by a media streaming platform. The steps shown in FIG. 2 may be performed by any suitable computer-executable code and/or computing system, including the systems illustrated in FIG. 1. In one example, each of the steps shown in FIG. 2 may represent an algorithm whose structure includes and/or is represented by multiple sub-steps, examples of which will be provided in greater detail below.

Method 200 includes, at 210, a step for receiving, at a server, at least a threshold number of connection requests 122 from multiple different client devices 118-120. Then, at step 220, the method 200 includes predicting an amount of time 109 expected to elapse before the server is able to service the connection requests 122. The method further includes, at step 230, calculating a retry distribution 111 for the client devices 118-120, where the retry distribution indicates a delayed time 112 after which the client devices are to send retry messages 122 to the server based on the predicted amount of time 109. At step 240, the method 200 then includes indicating, to the client devices 118-120, that the client devices are to send connection requests 122 according to the delayed time 112 specified in the calculated retry distribution 111.

In some embodiments, the delayed time 112 that was calculated by the distribution calculating module 110 of computer system 101 is based on at least one health indicator of the server. FIG. 3 illustrates various server health factors 301 that may be used when managing playback retries during playback of a (live) media item provisioned by a media streaming platform. For instance, in some cases, the distribution calculating module 110 of FIG. 1 identifies current CPU load on the server. This may include determining how many processes are currently running, how many CPU cycles are available, how high the average CPU load has been over the last hour, day, week, etc., CPU temperatures, number of CPU cores available, amount of L1 CPU cache available, or other CPU-related health factors.

Other server health factors 301 include memory (e.g., available RAM, available cache space, available north bridge bandwidth, available graphics processing unit (GPU) memory, etc.), available network bandwidth (e.g., available network nodes, router or gateway capacity, communications line capacity, etc.), hard disk drive (HDD) availability (e.g., how many megabytes or gigabytes per second are being used or are available, how many HDDs or solid-state drives are available, how much overall storage space is available, etc.), or other health factors that would affect the computing and networking operations of the server.

At least in some cases, the distribution calculating module 110 of computer system 101 also evaluates the server's restart capacity 302 when calculating a delay time 303. In addition to or at the exclusion of the server health factors 301, the distribution calculating module 110 may determine whether a given server node is available to begin accepting connection requests 122. In some cases, for instance, the media streaming platform has many hundreds, thousands, or millions of physical or logical servers that may be geographically dispersed all over the world. At least in some embodiments, each server will make its own decision regarding its ability to service connection requests based on the current status of its own server health factors 301.

In at least some embodiments, each server looks at the available bandwidth of the computing networks to which it is connected. If more bandwidth is available on the network, the calculated delay time 303 will be lower. And, on the other hand, if less bandwidth is available on the network, the calculated delay time 303 will be higher. At least in some cases, each connection request 122 will have its own unique calculated delay time 303, while in other cases, some of the connection requests may be grouped together and assigned the same delay time 303. After this delay time has expired, those nodes are free to send connection requests 122 to the server where, if the prediction was correct (e.g., based on the health factors 301 and/or the restart capacity 302), the server nodes will be able to respond to the connection requests.

In some cases, connection requests are received while the media streaming platform is provisioning a pre-recorded program. In other cases, connection requests are received while the media streaming platform is provisioning a live event such as a concert. In some examples, the number of connection requests is tallied at the server. Then, after receiving at least a threshold number of connection requests 122, the server begins predicting an amount of time needed to respond and begins calculating a retry distribution for those connection requests that have come in at the server. The threshold number may be predetermined and may be a fixed number or may be dynamically changed based on server health factors. In some cases, the threshold number of connection requests are initiated by users at the respective client devices 118-120. In other cases, the connection requests are initiated automatically by the client devices upon losing their connections to the server.

When the distribution calculating module 110 is generating the retry distribution for the received connection requests 122, the distribution calculating module 110 may add jitter to the retry messages received from the client devices 118-120. For instance, as shown in FIG. 4, the distribution calculating module calculates specific delayed times 112 for each client 402, 403, 404, 405, and 406 for connection requests involving live event 401. In this example, the distribution calculating module 110 adds jitter to the retry messages, such that the clients 402-406 send their retry messages at different points in time. For example, according to retry distribution 410, client 402 sends its connection request at time T1, client 403 sends its connection request at time T2, client 404 sends its connection request at time T3, client 405 sends its connection request at time T4, and client 406 sends its connection request at time T5. Each of the times T1-T5 are different and are specific to each client device. In other cases, as noted above, some clients may be grouped together and connection requests for each group are sent simultaneously.

In the embodiments of FIGS. 3 & 4, the retry distribution 410 and calculated delay time 303 are calculated to include a lowest possible backoff time. The “backoff time,” as the term is used herein, refers to an amount of time that the server will wait before allowing new connection requests to be sent by clients or the amount of time that the server will refuse incoming connection requests. At least in some embodiments, this backoff time is to be reduced to a lowest possible level to ensure that connection requests are serviced as soon as possible after a failure. In some cases, the backoff time that is ultimately applied to a given situation may be based on current server operating conditions, including the server health factors 301 and restart capacity factors 302 of FIG. 3.

In some embodiments, the connection requests 122 are generated when a client device loses audio signal or video signal during the live event or pre-recorded program. In such cases, the server of the media streaming platform may not be aware that the client device (or that many client devices) has lost video and/or audio. The client device(s) may automatically send connection requests, or the client device(s) may send connection requests at the initiation of a user that has noticed that the audio and/or video are no longer working.

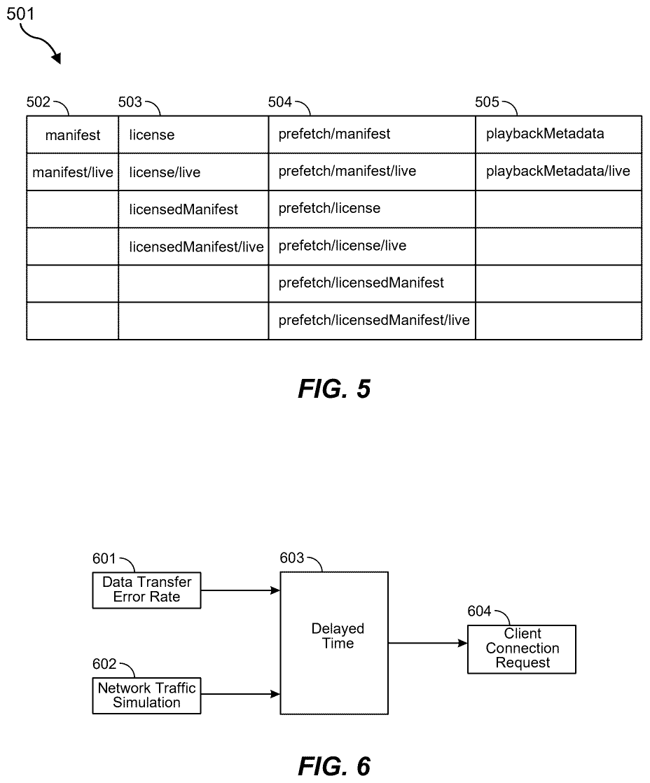

Still further, in some cases, the connection requests 122 correspond to specific message types. For instance, during operation of a client-server connection in a media streaming platform, the client and server will exchange different request and reply messages (e.g., messages 501 in FIG. 5). In some cases, different message types 501 are associated with different delay times or retry time windows in the retry distribution. For instance, in some embodiments, a manifest or live manifest message 502 is associated with a delay time T1 in FIG. 4, license messages or licensed manifest messages 503 are associated with a delay time T2, prefetch messages 504 (including manifests and license) are each associated with different delay times T3 or T4, and playback metadata messages 505 are associated with a delay time T5. It will be understood that other message types may be associated with other delay times.

Thus, in contrast with prior solutions that simply added a one second or two second or four second (and doubling) delay to all connection request messages, the embodiments herein apply specific delays or retry time windows to specific types of messages and calculate the delays based on various factors, including server health and restart capacity. As such, the process of delaying connection requests is customized and dynamically calculated for each unique situation, according to current server and network conditions and according to which types of messages are involved. This level of granularity and specificity has not been provided previously.

Still further, at least in some cases, the varying time windows for retry distribution are specific to individual media items. Thus, higher-priority media items (e.g., live events or new release movies) may have shorter time windows in the retry distribution, while lower-priority media items will have longer time windows in the retry distribution. Moreover, in some cases, one type of message may be dependent on another type. For instance, in some cases, license connection requests will not be processed until manifest connection requests are being processed by the server. Other types of connection requests will be denied at the server until the message types from which those retries depend are being fulfilled at the server. In this manner, dependencies between messages are accounted for when determining which retry messages are to be processed first. Furthermore, each specific media item or event may have its own retry time window or delay within the retry distribution. This associated time window can change over time (e.g., become longer) as the media item becomes less popular.

In some cases, the server (e.g., computer system 101 of FIG. 1) is configured to determine an error rate for data transferred between the server and a specified client device (e.g., 118, 119, or 120). The server then assigns a delayed time 112 for the retry distribution 111 that is based on the determined error rate. For instance, in some embodiments, the error rate determining module 114 of computer system 101 determines an error rate 115 for data transferred between the computer system and the client device 118. The error rate indicates the number of retryable HTTP errors between a client and a server. For example, such retryable errors may include HTTP status 500/502/503 errors or retryable errors due to the server being unable to communicate with its downstream services or databases. This error rate 115 is then used by the distribution calculating module 110 to (re) calculate the retry distribution.

In such cases, the delayed time 112 for the retry distribution 111 is based on how many retries can occur while staying below the specified error rate. If there is a higher error rate, the delay time or backoff time will be higher, as fewer data packets are being successfully transferred. Correspondingly, if the error rate is lower, the delay time 112 will be lower, as more data packets are being successfully transferred. This process is shown in FIG. 6, in which a data transfer error rate 601 is used, in conjunction with a network traffic simulation 602, to calculate a delay time 603 for a specific client. After that time has expired, the client can send a subsequent connection request message 604.

In some embodiments, the simulation module 116 of computer system 101 conducts a simulation that simulates network traffic 117 between the server and at least one client device 118. These simulation results, including the amount of simulated network traffic 117 (or 602 of FIG. 6) that is transferred in the simulation, are used to calculate the delayed time 112 for the retry distribution 111 based on the simulation results. For example, if the computer system 101 is provisioning a live event or a pre-recorded media item (e.g., a media title 126 stored in database 125), the simulation module 116 may simulate a failure occurring at the computer system. Or, if a failure occurs, the computer system may simulate receiving a plurality of connection requests. The simulation may take into account current server health factors and/or server restart capacity to determine how many connection requests can be processed and how long to delay the requests in the retry distribution.

In some cases, the server is configured to send control signals to various client devices (e.g., 118-120) indicating that those client devices are prevented from sending connection requests. Upon receiving these control signals from the server, the client devices will not be able to send connection requests for a specified amount of time. After that time window has expired, the client devices will again be able to send connection requests. In some embodiments, the server will additionally or alternatively instruct the client devices to store state data indicating a last retry time. The last retry time indicates the time at which the last connection request was sent by the client to the server. Storing this state data allows the client to communicate to the server the last time it sent a connection request. In some cases, clients that have gone longer without sending a connection request are prioritized higher than clients that have more recently sent a connection request. In this manner, many different factors are considered when determining delay times for a retry distribution, including the health of the server, the server's current restart capacity, the type of messages sent, the dependencies of the message, transmission error rates, the last time a connection request was sent, etc. Such factors provide a robust and customizable solution to handling connection requests in a media streaming platform.

In addition to the above-described method, a system may be provided that includes at least one physical processor and physical memory comprising computer-executable instructions that, when executed by the physical processor, cause the physical processor to: receive, at a server, at least a threshold number of connection requests from a plurality of different client devices, predict an amount of time expected to elapse before the server is able to service the connection requests, calculate a retry distribution for the plurality of client devices, wherein the retry distribution indicates a delayed time after which one or more of the plurality of client devices are to send retry messages to the server based on the predicted amount of time, and indicate, to the one or more client devices, that the one or more client devices are to send connection requests according to the delayed time specified in the calculated retry distribution.

Still further, in addition to the above-described method, a non-transitory computer-readable medium may be provided that includes one or more computer-executable instructions that, when executed by at least one processor of a computing device, cause the computing device to: receive, at a server, at least a threshold number of connection requests from a plurality of different client devices, predict an amount of time expected to elapse before the server is able to service the connection requests, calculate a retry distribution for the plurality of client devices, wherein the retry distribution indicates a delayed time after which one or more of the plurality of client devices are to send retry messages to the server based on the predicted amount of time, and indicate, to the one or more client devices, that the one or more client devices are to send connection requests according to the delayed time specified in the calculated retry distribution.

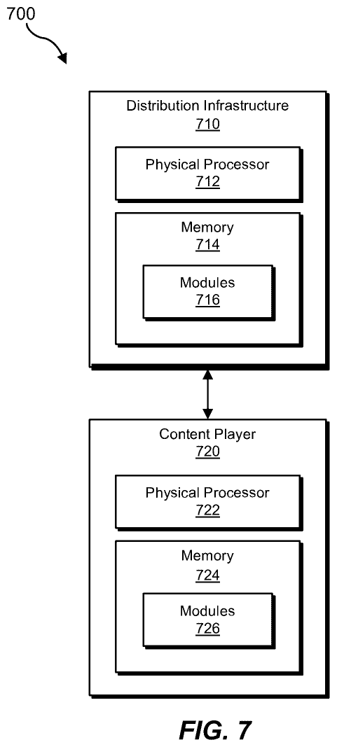

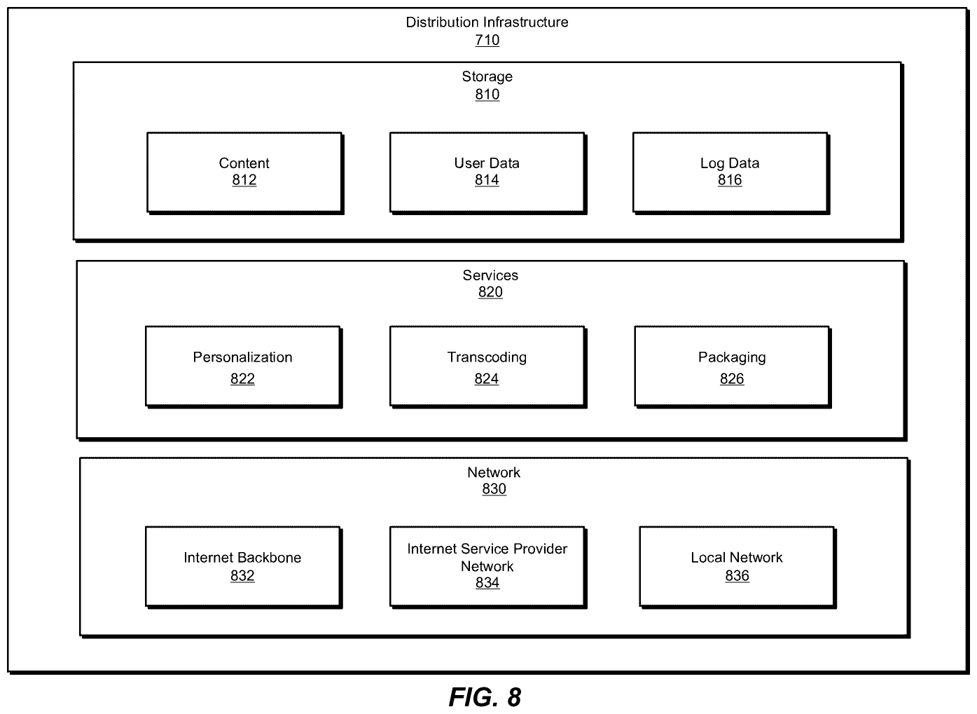

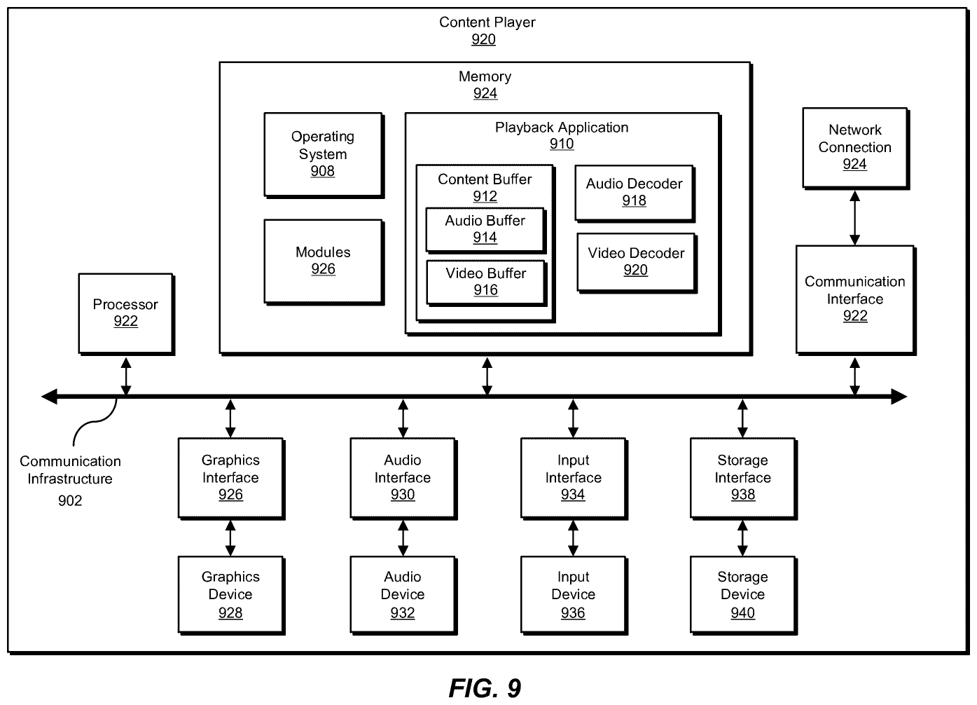

The following will provide, with reference to FIG. 7, detailed descriptions of exemplary ecosystems in which content is provisioned to end nodes and in which requests for content are steered to specific end nodes. The discussion corresponding to FIGS. 8 and 9 presents an overview of an exemplary distribution infrastructure and an exemplary content player used during playback sessions, respectively. These exemplary ecosystems and distribution infrastructures are implemented in any of the embodiments described above with reference to FIGS. 1-9.

FIG. 7 is a block diagram of a content distribution ecosystem 700 that includes a distribution infrastructure 710 in communication with a content player 720. In some embodiments, distribution infrastructure 710 is configured to encode data at a specific data rate and to transfer the encoded data to content player 720. Content player 720 is configured to receive the encoded data via distribution infrastructure 710 and to decode the data for playback to a user. The data provided by distribution infrastructure 710 includes, for example, audio, video, text, images, animations, interactive content, haptic data, virtual or augmented reality data, location data, gaming data, or any other type of data that is provided via streaming.

Distribution infrastructure 710 generally represents any services, hardware, software, or other infrastructure components configured to deliver content to end users. For example, distribution infrastructure 710 includes content aggregation systems, media transcoding and packaging services, network components, and/or a variety of other types of hardware and software. In some cases, distribution infrastructure 710 is implemented as a highly complex distribution system, a single media server or device, or anything in between. In some examples, regardless of size or complexity, distribution infrastructure 710 includes at least one physical processor 712 and at least one memory 714. One or more modules 716 are stored or loaded into memory 714 to enable adaptive streaming, as discussed herein.

Content player 720 generally represents any type or form of device or system capable of playing audio and/or video content that has been provided over distribution infrastructure 710. Examples of content player 720 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 710, content player 720 includes a physical processor 722, memory 724, and one or more modules 726. Some or all of the adaptive streaming processes described herein is performed or enabled by modules 726, and in some examples, modules 716 of distribution infrastructure 710 coordinate with modules 726 of content player 720 to provide adaptive streaming of digital content.

In certain embodiments, one or more of modules 716 and/or 726 in FIG. 7 represent one or more software applications or programs that, when executed by a computing device, cause the computing device to perform one or more tasks. For example, and as will be described in greater detail below, one or more of modules 716 and 726 represent modules stored and configured to run on one or more general-purpose computing devices. One or more of modules 716 and 726 in FIG. 7 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 712 and 722 generally represent any type or form of hardware-implemented processing unit capable of interpreting and/or executing computer-readable instructions. In one example, physical processors 712 and 722 access and/or modify one or more of modules 716 and 726, respectively. Additionally or alternatively, physical processors 712 and 722 execute one or more of modules 716 and 726 to facilitate adaptive streaming of digital content. Examples of physical processors 712 and 722 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 714 and 724 generally represent any type or form of volatile or non-volatile storage device or medium capable of storing data and/or computer-readable instructions. In one example, memory 714 and/or 724 stores, loads, and/or maintains one or more of modules 716 and 726. Examples of memory 714 and/or 724 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 8 is a block diagram of exemplary components of content distribution infrastructure 710 according to certain embodiments. Distribution infrastructure 710 includes storage 810, services 820, and a network 830. Storage 810 generally represents any device, set of devices, and/or systems capable of storing content for delivery to end users. Storage 810 includes a central repository with devices capable of storing terabytes or petabytes of data and/or includes distributed storage systems (e.g., appliances that mirror or cache content at Internet interconnect locations to provide faster access to the mirrored content within certain regions). Storage 810 is also configured in any other suitable manner.

As shown, storage 810 may store a variety of different items including content 812, user data 814, and/or log data 816. Content 812 includes television shows, movies, video games, user-generated content, and/or any other suitable type or form of content. User data 814 includes personally identifiable information (PII), payment information, preference settings, language and accessibility settings, and/or any other information associated with a particular user or content player. Log data 816 includes viewing history information, network throughput information, and/or any other metrics associated with a user's connection to or interactions with distribution infrastructure 710.

Services 820 includes personalization services 822, transcoding services 824, and/or packaging services 826. Personalization services 822 personalize recommendations, content streams, and/or other aspects of a user's experience with distribution infrastructure 710. Encoding services 824 compress media at different bitrates which, as described in greater detail below, enable real-time switching between different encodings. Packaging services 826 package encoded video before deploying it to a delivery network, such as network 830, for streaming.

Network 830 generally represents any medium or architecture capable of facilitating communication or data transfer. Network 830 facilitates communication or data transfer using wireless and/or wired connections. Examples of network 830 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 8, network 830 includes an Internet backbone 832, an internet service provider 834, and/or a local network 836. As discussed in greater detail below, bandwidth limitations and bottlenecks within one or more of these network segments triggers video and/or audio bit rate adjustments.

FIG. 9 is a block diagram of an exemplary implementation of content player 720 of FIG. 7. Content player 720 generally represents any type or form of computing device capable of reading computer-executable instructions. Content player 720 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 9, in addition to processor 722 and memory 724, content player 720 includes a communication infrastructure 902 and a communication interface 922 coupled to a network connection 924. Content player 720 also includes a graphics interface 926 coupled to a graphics device 928, an input interface 934 coupled to an input device 936, and a storage interface 938 coupled to a storage device 940.

Communication infrastructure 902 generally represents any type or form of infrastructure capable of facilitating communication between one or more components of a computing device. Examples of communication infrastructure 902 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 724 generally represents any type or form of volatile or non-volatile storage device or medium capable of storing data and/or other computer-readable instructions. In some examples, memory 724 stores and/or loads an operating system 908 for execution by processor 722. In one example, operating system 908 includes and/or represents software that manages computer hardware and software resources and/or provides common services to computer programs and/or applications on content player 720.

Operating system 908 performs various system management functions, such as managing hardware components (e.g., graphics interface 926, audio interface 930, input interface 934, and/or storage interface 938). Operating system 908 also provides process and memory management models for playback application 910. The modules of playback application 910 includes, for example, a content buffer 912, an audio decoder 918, and a video decoder 920.

Playback application 910 is configured to retrieve digital content via communication interface 922 and play the digital content through graphics interface 926. Graphics interface 926 is configured to transmit a rendered video signal to graphics device 928. In normal operation, playback application 910 receives a request from a user to play a specific title or specific content. Playback application 910 then identifies one or more encoded video and audio streams associated with the requested title. After playback application 910 has located the encoded streams associated with the requested title, playback application 910 downloads sequence header indices associated with each encoded stream associated with the requested title from distribution infrastructure 710. A sequence header index associated with encoded content includes information related to the encoded sequence of data included in the encoded content.

In one embodiment, playback application 910 begins downloading the content associated with the requested title by downloading sequence data encoded to the lowest audio and/or video playback bitrates to minimize startup time for playback. The requested digital content file is then downloaded into content buffer 912, which is configured to serve as a first-in, first-out queue. In one embodiment, each unit of downloaded data includes a unit of video data or a unit of audio data. As units of video data associated with the requested digital content file are downloaded to the content player 720, the units of video data are pushed into the content buffer 912. Similarly, as units of audio data associated with the requested digital content file are downloaded to the content player 720, the units of audio data are pushed into the content buffer 912. In one embodiment, the units of video data are stored in video buffer 916 within content buffer 912 and the units of audio data are stored in audio buffer 914 of content buffer 912.

A video decoder 920 reads units of video data from video buffer 916 and outputs the units of video data in a sequence of video frames corresponding in duration to the fixed span of playback time. Reading a unit of video data from video buffer 916 effectively de-queues the unit of video data from video buffer 916. The sequence of video frames is then rendered by graphics interface 926 and transmitted to graphics device 928 to be displayed to a user.

An audio decoder 918 reads units of audio data from audio buffer 914 and outputs the units of audio data as a sequence of audio samples, generally synchronized in time with a sequence of decoded video frames. In one embodiment, the sequence of audio samples is transmitted to audio interface 930, which converts the sequence of audio samples into an electrical audio signal. The electrical audio signal is then transmitted to a speaker of audio device 932, which, in response, generates an acoustic output.

In situations where the bandwidth of distribution infrastructure 710 is limited and/or variable, playback application 910 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 926 is configured to generate frames of video data and transmit the frames of video data to graphics device 928. In one embodiment, graphics interface 926 is included as part of an integrated circuit, along with processor 722. Alternatively, graphics interface 926 is configured as a hardware accelerator that is distinct from (i.e., is not integrated within) a chipset that includes processor 722.

Graphics interface 926 generally represents any type or form of device configured to forward images for display on graphics device 928. For example, graphics device 928 is fabricated using liquid crystal display (LCD) technology, cathode-ray technology, and light-emitting diode (LED) display technology (either organic or inorganic). In some embodiments, graphics device 928 also includes a virtual reality display and/or an augmented reality display. Graphics device 928 includes any technically feasible means for generating an image for display. In other words, graphics device 928 generally represents any type or form of device capable of visually displaying information forwarded by graphics interface 926.

As illustrated in FIG. 9, content player 720 also includes at least one input device 936 coupled to communication infrastructure 902 via input interface 934. Input device 936 generally represents any type or form of computing device capable of providing input, either computer or human generated, to content player 720. Examples of input device 936 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 720 also includes a storage device 940 coupled to communication infrastructure 902 via a storage interface 938. Storage device 940 generally represents any type or form of storage device or medium capable of storing data and/or other computer-readable instructions. For example, storage device 940 is a magnetic disk drive, a solid-state drive, an optical disk drive, a flash drive, or the like. Storage interface 938 generally represents any type or form of interface or device for transferring data between storage device 940 and other components of content player 720.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

### Example Embodiments

Example 1: A computer-implemented method comprising: receiving, at a server, at least a threshold number of connection requests from a plurality of different client devices, predicting an amount of time expected to elapse before the server is able to service the connection requests, calculating a retry distribution for the plurality of client devices, wherein the retry distribution indicates a delayed time after which one or more of the plurality of client devices are to send retry messages to the server based on the predicted amount of time, and indicating, to the one or more client devices, that the one or more client devices are to send connection requests according to the delayed time specified in the calculated retry distribution.

Example 2. The computer-implemented method of Example 1, wherein the calculated delayed time is based on at least one health indicator of the server.

Example 3. The computer-implemented method of Example 1 or Example 2, wherein the calculated delayed time is based on a determined restart capacity of the server.

Example 4. The computer-implemented method of any of Examples 1-3, wherein receiving at least the threshold number of connection requests includes identifying at least a threshold number of connection requests that are initiated by users at the respective client devices.

Example 5. The computer-implemented method of any of Examples 1-4, wherein the calculated retry distribution adds jitter to the retry messages received from the client devices.

Example 6. The computer-implemented method of any of Examples 1-5, wherein the retry distribution is calculated to include a lowest possible backoff time based on current server operating conditions.

Example 7. The computer-implemented method of any of Examples 1-6, wherein the connection requests received from the plurality of different client devices are received while provisioning a live event at the server.

Example 8. The computer-implemented method of any of Examples 1-7, wherein one or more of the connection requests are generated by users manually re-starting the stream upon the associated client device losing audio signal or video signal during the live event.

Example 9. The computer-implemented method of any of Examples 1-8, wherein receiving at least the threshold number of connection requests includes identifying at least a threshold number of connection requests that are initiated automatically by the respective client devices.

Example 10. The computer-implemented method of any of Examples 1-9, further comprising instructing one or more of the client devices to store state data indicating a last retry time.

Example 11. The computer-implemented method of any of Examples 1-10, wherein the connection requests correspond to a plurality of different message types.

Example 12. The computer-implemented method of any of Examples 1-11, wherein each of the different message types is associated with a different time window for retry distribution.

Example 13. The computer-implemented method of any of Examples 1-12, wherein the different time windows for retry distribution are specific to individual media items.

Example 14. A system comprising at least one physical processor and physical memory comprising computer-executable instructions that, when executed by the physical processor, cause the physical processor to: receive, at a server, at least a threshold number of connection requests from a plurality of different client devices, predict an amount of time expected to elapse before the server is able to service the connection requests, calculate a retry distribution for the plurality of client devices, wherein the retry distribution indicates a delayed time after which one or more of the plurality of client devices are to send retry messages to the server based on the predicted amount of time, and indicate, to the one or more client devices, that the one or more client devices are to send connection requests according to the delayed time specified in the calculated retry distribution.

Example 15. The system of Example 14, further comprising: determining an error rate for data transferred between the server and a specified client device, and assigning a delayed time for the retry distribution that is based on the determined error rate.

Example 16. The system of Example 14 or Example 15, wherein the delayed time for the retry distribution is based on how many retries can occur while staying below the specified error rate.

Example 17. The system of any of Examples 14-16, further comprising: conducting a simulation that simulates network traffic between the server and at least one client device and calculating the delayed time for the retry distribution based on the simulation results.

Example 18. The system of Examples 14-17, further comprising sending control signals to a specified client device indicating that the specified client device is prevented from sending connection requests.

Example 19. The system of any of Examples 14-18, wherein at least one type of connection request is denied at the server until a different type of connection request is being fulfilled at the server.

Example 20. A non-transitory computer-readable medium comprising one or more computer-executable instructions that, when executed by at least one processor of a computing device, cause the computing device to: receive, at a server, at least a threshold number of connection requests from a plurality of different client devices, predict an amount of time expected to elapse before the server is able to service the connection requests, calculate a retry distribution for the plurality of client devices, wherein the retry distribution indicates a delayed time after which one or more of the plurality of client devices are to send retry messages to the server based on the predicted amount of time, and indicate, to the one or more client devices, that the one or more client devices are to send connection requests according to the delayed time specified in the calculated retry distribution.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, at a server, at least a threshold number of connection requests from a plurality of different client devices;
predicting an amount of time expected to elapse before the server is able to service the connection requests;
calculating a retry distribution for the plurality of client devices, wherein the retry distribution indicates a delayed time after which one or more of the plurality of client devices are to send retry messages to the server based on the predicted amount of time; and
indicating, to the one or more client devices, that the one or more client devices are to send connection requests according to the delayed time specified in the calculated retry distribution.

2. The computer-implemented method of claim 1, wherein the calculated delayed time is based on at least one health indicator of the server.

3. The computer-implemented method of claim 1, wherein the calculated delayed time is calculated for each server and is based on at least one of: central processing unit (CPU) availability, memory availability, or network bandwidth availability.

4. The computer-implemented method of claim 1, wherein receiving at least the threshold number of connection requests includes identifying at least a threshold number of connection requests that are initiated by users at the respective client devices.

5. The computer-implemented method of claim 1, wherein the calculated retry distribution adds jitter to the retry messages received from the client devices.

6. The computer-implemented method of claim 1, wherein the retry distribution is calculated to include a lowest possible backoff time based on current server operating conditions.

7. The computer-implemented method of claim 1, wherein the connection requests received from the plurality of different client devices are received while provisioning a live event at the server.

8. The computer-implemented method of claim 7, wherein one or more of the connection requests are generated by users manually re-starting the stream upon an associated client device of the plurality of different client devices losing audio signal or video signal during the live event.

9. The computer-implemented method of claim 1, wherein receiving at least the threshold number of connection requests includes identifying at least a threshold number of connection requests that are initiated automatically by the respective client devices.

10. The computer-implemented method of claim 1, further comprising instructing one or more of the client devices to store state data indicating a last retry time.

11. The computer-implemented method of claim 1, wherein the connection requests correspond to a plurality of different message types.

12. The computer-implemented method of claim 11, wherein each of the different message types is associated with a different time window for retry distribution.

13. The computer-implemented method of claim 12, wherein the different time windows for retry distribution are specific to individual media items.

14. A system comprising:
at least one physical processor; and
physical memory comprising computer-executable instructions that, when executed by the physical processor, cause the physical processor to:
receive, at a server, at least a threshold number of connection requests from a plurality of different client devices;
predict an amount of time expected to elapse before the server is able to service the connection requests;
calculate a retry distribution for the plurality of client devices, wherein the retry distribution indicates a delayed time after which one or more of the plurality of client devices are to send retry messages to the server based on the predicted amount of time; and
indicate, to the one or more client devices, that the one or more client devices are to send connection requests according to the delayed time specified in the calculated retry distribution.

15. The system of claim 14, further comprising:
determining an error rate for data transferred between the server and a specified client device; and
assigning a delayed time for the retry distribution that is based on the determined error rate.

16. The system of claim 15, wherein the delayed time for the retry distribution is based on how many retries can occur while staying below the specified error rate.

17. The system of claim 14, further comprising:
conducting a simulation that simulates network traffic between the server and at least one client device; and
calculating the delayed time for the retry distribution based on results of the simulation.

18. The system of claim 14, further comprising sending control signals to a specified client device indicating that the specified client device is prevented from sending connection requests.

19. The system of claim 14, wherein at least one type of connection request is denied at the server until a different type of connection request is being fulfilled at the server.

20. A non-transitory computer-readable medium comprising one or more computer-executable instructions that, when executed by at least one processor of a computing device, cause the computing device to:
receive, at a server, at least a threshold number of connection requests from a plurality of different client devices;
predict an amount of time expected to elapse before the server is able to service the connection requests;
calculate a retry distribution for the plurality of client devices, wherein the retry distribution indicates a delayed time after which one or more of the plurality of client devices are to send retry messages to the server based on the predicted amount of time; and
indicate, to the one or more client devices, that the one or more client devices are to send connection requests according to the delayed time specified in the calculated retry distribution.
